(19) United States
(12) Patent Application Publication
(10) Pub. No.: US 2019/0209930 A1
(43) Pub. Date: Jul. 11, 2019

(54) SYSTEM FOR INTERACTIVE MONSTER CREATION

(71) Applicant: STEPHEN THAMM, SAINT AUGUSTINE, FL (US)

(72) Inventor: STEPHEN THAMM, SAINT AUGUSTINE, FL (US)

(21) Appl. No.: 15/868,036

(22) Filed: Jan. 11, 2018

(51) Int. Cl. A63F 13/825; A63F 13/63

(52) U.S. Cl. CPC A63F 13/825; A63F 13/63

(57) ABSTRACT

A system to create interactive monster images that includes: an interactive science lab, wherein a user enters the interactive science lab through a software application; an assortment of equipment within the interactive science lab such as flasks, beakers, test tubes and DNA research; interactive monster images created by the user using the assortment of equipment by cloning, breeding or genetically altering characteristics; various levels of participation based on player activity; a variety of ingredients for monster image creation such as swamp water, flesh, teeth, tears, human heart, tentacles, eyeballs, scales of the hand, skin, snakeskin, worms, roaches, lizards; a purchasing option available to purchase a selection of the variety of ingredients for creation of the monster images.

### BACKGROUND OF THE INVENTION

### Field of Invention

The present invention relates to an interactive game based upon monster creation.

### Description of Related Art

Interactive games are a popular past time in modern society. Interactive games are principally video games that include a platform with user controllers to control engagement with the game. Interactive games are based upon a plethora of formats include action games, adventures games, role playing games, simulation games, strategy games and vehicle simulation. The games may include single or multiplayer formats. Further team play may also be available in certain games. The gamers use a variety of video game hardware platforms for gaming such as gaming consoles, mobile gaming, online gaming and PC gaming. The games may have various levels of difficulty and formats for specific engagement. Due to the wide popularity of gaming and interest therein, it is always interest in new gaming formats and genres. It is the object of the present invention to provide unique monster creation gaming experience.

### SUMMARY OF THE INVENTION

The present invention relates to a system to create interactive monster images that includes: an interactive science lab, wherein a user enters the interactive science lab through a software application; an assortment of equipment within the interactive science lab such as flasks, beakers, test tubes and DNA research; interactive monster images created by the user using the assortment of equipment by cloning, breeding or genetically altering characteristics; various levels of participation based on player activity; a variety of ingredients for monster image creation such as swamp water, flesh, teeth, tears, human heart, tentacles, eyeballs, scales of the hand, skin, snakeskin, worms, roaches, lizards; a purchasing option available to purchase a selection of the variety of ingredients for creation of the monster images. A series of missions are engaged through the monster creation process and the user engages in various monster activities to improve monster characteristics such as biting, attacking, feeding and engaging in tournaments. Also through user engagement, parameters may be set and associated with each monster image such as healing capabilities, fighting capabilities and hunting capabilities.

### DETAIL DESCRIPTION

The present invention relates to a system to create system and method to create images of interactive monster images and engage in various activities via interactive graphical display. The system of the present invention is created via a mobile application available through a mobile device such as a smart phone or tablet. The system is set up in an interactive science lab where the user is behaves as a mad scientist and builds/upgrades a science lab by using desired equipment such flasks, beakers, test tubes, DNA research, etc. The user interactively uses the equipment to create monsters by cloning, breeding or genetically altering characteristics available in the science lab. The user may also create a ½ vampire or ½ whatever . . . upgrade your monsters abilities . . . to fight online . . . epic monsters and new monsters gained as you upgrade or generated through random events . . . hidden monsters as the game progresses . . . and new science equipment brings your squad of monsters to epic levels. If you neglect the app. Science lab goes haywire . . . explosions. Smoke. Slim . . . electric sparks. Water leaks . . . Watch DNA mix, beakers bubble, Bunsen burners flames change colors. Test tubes overflow. Change color. Feed and watch your monsters grow potions and elixirs increase power. Certain monsters have an advantage in a fight due to their abilities. The science lab is a constant, viewable interactive arrangement that the user can play or sit back and watch your world come to life. The interactive format is available in virtual reality or non-virtual reality also (mythological monsters from different cultures around the world) . . . .

A user may unlock new science equipment by performing experiments and completing random missions. PLAYER upgrades level as game progresses (fights and mission completions) when new materials become available 1 of 2 sets of items will randomly generate depending on your LEVEL 1-infinite. Some people get item's A others item's B . . . you will eventually get the other monster, within the next few levels. This will keep the battles interesting with different characters. A set of 5 random characters unlock IN the first 10 levels player gains . . . No duplicates. (Game knows who you already own). after that 1 character every 10 levels gained . . . levels 22 and 25 unlock 2 secret monsters. LEVEL 53 unlock secret monster. Level 79 unlock secret monster. Level 101 unlock secret monster.

Various ingredients are available for use such as: add swamp water; Graveyard dirt; Slim; radioactive ooze; flesh; teeth; a human heart; tears; liquid hate; tentacles; eye ball; a puppy; a cat; electric eel; fish; a raven; skeleton hand; snake skin; worms; roaches; lizard; dust; poop; urine; moth; baby hair; vomit; boogers and snot; finger nails; ocean water; lava; mud; rose peddles; oak leaves; jungle vines; cobra venom; shark teeth; crab legs; black widow spider; bag of old garbage; fish guts; human intestines; rusty medallion; dentures; rotten eggs; and fried chicken. These ingredients are combined and used to create the monster environment.

You can purchase some of the ingredients with radioactive ooze inside the games store all ingredients are used to create your monsters. Once you have an ingredient you own it forever. Making multiple attempts to create different ingredient combinations unlocks secret monsters. The only way to unlock them is to play with your science equipment.

(Look at Your Science Log to See What You have Created)
Random missions: 1: set up lab 2: turn on burner 3: 1st experiment 4: feed monster 10 times 5: create female 6: upgrade test tubes 1 time 7: upgrade test tube 2 time 8: upgrade test tube 3 times 9: upgrade burner 1 time 10: upgrade burner 2 times 11: upgrade burner 3 times 12: add gas tubes 13: add radioactive material storage 14: add dna accelerator 15: add gene manipulator machine 16: eat 10 humans 17: eat 20 humans 18: eat 50 humans 19: eat 80 humans 20: eat 100 humans 21: eat 200 humans 22: eat 250 humans 23: eat 350 humans 24: eat 500 humans 25: eat 1000 humans 26: win 1st fight 27: win 3 fights in a row 28: win 10 total fights 29 win 5 fights in a row 30: win 10 fights in a row 31: win 20 fights in a row 32: win 50 fights in a row 33: win 75 fights in a row 34: win 20 total fights 35: win 50 total fights 36: win 75 fights 37: win 100 fights 38: fix your monster's injures once 39: fix monster 5 times 40 fix monster 10 times 41: fix monster 20 times 42: fix monster 30 times 43: fix monster 50 times 44: fix monster 75 times 45: fix monster 100 times 46: fix monster 150 times 47 fix monster 200 times 48 fix monster 225 times 49 fix monster 275 times 50: fix monster 300 times 51: feed monster 20 Times 52: feed monster 50 times 53: feed monster 100 times 54 fix 1 broken test tube 55: fix 3 broken test tubes 56: fix 10 broken test tubes 57: fix 30 broken test tubes 58: fix 50 broken test tubes 59: look at test tube reactions 1 time 60: look at test tube 5 times 61: look at test tube 20 times 62: look at test tube 100 times 63: visit lab 1 day in a row 64 visit lab 2 days in a row 65: visit lab 3 days in a row 66: visit lab 4 days in a row 67: visit lab 5 days in a row 68: visit lab 6 days in a row 69: visit lab 7 days in a row 70: visit lab 14 days in a row 71: visit lab 30 days in a row 72 visit lab 90 days in a row 73: visit lab 180 days in a row 74: visit lab 365 days in a row 75: breed 2 monsters 76: breed 2 special monsters 77: buy an epic mineral to create epic monster 78: unlock extra test tubes 79: clean up radioactive spill. 80: collect all monsters 81: lose first fight 82: lose 10 fights 83: lose 20 fights 84 lose 30 fights 85: lose 40 fights 86: lose 50 fights 87: lose 75 fights 88: lose 100 fights 89: lose 20 fights in a row 90: lose 50 fights in a row 91: invite 5 friends 92: invite 10 friends 93: invite 20 friends 94: invite 100 friends 95 beat 10 friends 96: beat 20 friends 97: beat 30 friends 98: beat 50 friends 99: beat 75 friends 100: beat 100 friends 101: beat 1000 friends 102: collect 3 monsters 103: collect 5 monsters 104: collect 10 monsters 105: collect 15 monsters 106: collect 20 monsters 107: buy epic monster 108: buy rare material 109: watch 20 advertisements 110: rate monster lab 5 stars 111: spend 100$ us dollars 112: spend 5$ us dollars 113: visit another players lab 114: heal another players monster 115: beat 10 computer mode monsters (non online battle) (purchase only characters . . . ) 116: send a friend monster food 117: come back win (come back from losing to win the fight) 118: unlock female character 119: win a quarterly tournament 120: win annual champions tournament 121: breed with a friend (takes 7 days-30 days depending on players level). 122: spend total of 100$us dollars 123: spend total of 10$us dollars 124: spend total of 20$us dollars 125: spend total of 100$ us dollars 126: open 10 total mystery box 127: open 20 total mystery box 128: collect 5 rare monsters 129 collect 10 rare monsters 130: don't play app for 5 days in a row 131: don't play app for 10 days in a row 132: treat monster nice 133: beat your monster 134: make monster giggle 135: make monster yell 136: make monster fart 137: make monster puke 138: make monster laugh 139: make monster angry 140: starve monster 141: tease monster with food. 142: make monster do a trick (tease with food long enough for monster to do a flip)

### (More Missions to Come)

Mini game: run your monster through the streets eating as many humans as possible in 90 seconds. (fills monster food bag) (every 10 humans equals 1 bag of food) . . . available once every 20 minutes. (MORE MINI GAMES TO COME) watch commercial to access it again before 20 minutes pass. As your level increase so does the strength of the humans. If your monster is not strong enough he doesn't eat and the humans kill you. Health bar is depleted in mini game only. Monsters battle health not affected.
Intro: Level 1: set up science lab. Place free beaker test tubes and Bunsen burner on the table . . . a free box of supplies pops up on the screen. Open it and receive graveyard dirt. (Flesh or bone dust) and neon green radiation ooze. Combine the ingredients and unlock a character. Tap the Bunsen burner to turn it on. Add your free ingredients to the test tube . . . wait 30 seconds for the reaction to take place (watch each test tube change in front of your eyes) drag the beaker to your burner add test tube and radioactive ooze. This creates a zombie or vampire . . . (random female vampire) 1 female vampire every 5000 downloads. All other females must be purchased. Feed the monster with monster food and watch it grow . . . (5 minutes). Now it is time to fight . . . push the arena button on your screen. Choose to fight online or computer. (fight the computer to upgrade the monsters skills (hit power and life) 10 purchase only computer controlled monsters ranging from easy to especially hard. OR fight RANDOM online player with in your skill level range . . . online battles are worth more experience points and ooze levels. . . . Each fight won fills your radioactive ooze 10-100 ml . . . and experience points depending on difficulty . . . (also buy ooze) . . . Ooze is needed to create the reaction for monster life. (It also is used to strengthen your monsters before a fight “boost of power”) and as an in app currency ($) to purchase new items (ingredients, Monsters, equipment, accessories, upgrades, and extra rooms. “use wisely”. Random missions give you monster food (that's needed to grow). Some monsters eat more food. As you feed your monster it will grow stronger, larger, and sometimes fatter (if you feed and don't fight) (purchase food with us dollars) (10 bags for 1$ us dollar). every level you increase unlocks the ability to use (monsters, dna machine, extra test tubes, hotter burner, bigger beaker and the epic monster morphing machine) . . . every level you gain also gives Free (food, ooze, and random materials).

Monster injuries take time to heal (5 minutes—2 days) (spend money to speed it up. (OR watch advertisement, limit 5 per hour). purchase time accelerators for 1$ us dollar per hour (divided into 5 minute increments). Run out of (food, ooze, or need to speed up time) watch advertisement video to get free items or buy in the game.

UNLOCK: monsters at levels 1, 3, 5, 8, 10 . . . 20, 22, 25, 30, and in increments of 10 after level 30 is reached. Experience points for winning low level fights (1-3) 25 points (4-8) 50 points (9-18) 75 points (19-30) 100 points . . . Each level is increased once you reach a specified point total . . . (level 2=2000 experience points).
Unlock: 1 more test tubes level 10. (Make more than 1 monster at a time) “all creations take specified time to finish”: Larger beaker at level 12: bigger burner level 15: gas bubble tubes level 18: DNA machine level 25: Gene manipulator machine level 40: high voltage electricity level 22: Toxic gas tanks level 19: water tank to hold aquatic monsters level 20: GENDER MODIFICATION (ONLY WITH predetermined MONSTERSS) level 100.

GAME CONTROLS . . . TAP AND DRAG ITEMS IN The Lab . . . move items from test tubes, then pour into other science equipment. Turn off and on burners by tapping the item. Tap screen to fix broken test tubes (all equipment will break down randomly if you neglect the app for more than 6 hours). tap test tubes to zoom in and out (watch the reaction mix and bubble and glow, steam, spill, smoke, change color, freeze, solidify, burn, mix, swirl, sediment develops, it looks like beef stew, spaghetti with sauce, water spouts, tornadoes, hurricanes, dead fish floating,). (5 minutes—72 hours) mix final product into beaker with ooze by dragging both the test tube and ooze to the beaker. drag the beaker to flame burner. Tap cooking beaker to zoom in and out (watch the monster change and take form), (all reactions take 5-60 minutes), (solids and liquids separate from the heat. They start to attack each other. Bumping into, bite, reactions infect by entering the opposite item, Solid absorbs liquid, It catches fire, it melts, then your creature starts to grow. TAP completed monster to send it into the cage. (Monsters automatically move to a cage) Tap monster cage to play with your monster. TAP monster to punch, scratch monsters back, tickle, poke, pet, and give attention too. Tap monster food bag and drag food over to your monster (when you let go it will fall. Hold it to tease your monster), If you over feed your monster he will throw up. (unlock puke) If you continue to feed monster farts (UNLOCK poop). BEAT up your monster by tapping fast anywhere on the monster (unlock tears if monster cries). TICKLE monster by slowly stroking monsters feet, arm pit, or neck. PET monster by slowly stroking your monster's head (unlocks butterflies).

Mini game controls: move forward or backward by pressing that direction. A (attack) B (block) C(RUN).
FIGHTING CONTROLS: (touch toward opponent or touch away from opponents) A. B. C. (buttons on the screen). A: PUNCHES B: KICKS OR SWINGS TAIL
A+B: (same time) super power C: BLOCKS
In app purchases: (ooze, or $$us dollars): time speedup: monster food: radioactive ooze: rare material box: rare monsters: rare science equipment: performance upgrades: Experience points: power elixir give monster super powers (permanently): ingredients to create monsters: extra test tubes: hotter larger burners: larger beaker: high voltage electricity: Lava crucible (holds lava): monster dungeon (allows more than 2 monsters): Heavy rubber gloves (shock proof): monster recovery room (needed to repair monsters): large water tank (to hold more than 1 water monsters): large bird cage (holds flying monsters): medium ooze container: larger ooze container: mega ooze container: epic ooze container: particle accelerator (like cern): bio lab (turn monsters into cyborgs)(splice 2 monsters together)(customize monsters features to what you want): mystery box (contains 1 of 10 extra monsters, or food and 2 rare ingredients, or special equipment and time manipulator or food, time, and 1 rare ingredient: epic box (contains 1 of 10 epic monsters)

### Monsters:

ZOMBIE, WEREWOLVES, (MALE, OR FEMALE) VAMPIRE (male or female), Tree monster Jungle tree monster Trash monster Old lady (can not breed her)(she says “disgusting” in a British accent) Cobra headed monster SNAKE skin man monster Banshee (female) Ghoul Octopus man monster Conjoined twin baby monster Black cat monster Roach monster Minator Cerberus Demons (male or female) Electric eel monster man Shark man monster Crab monster Raven monster Phoenix Eagle Dragon Succubus Grass hopper monster Fish man (sheep head fish) Mermaid (female) Trolls Sprigs (flying monster) Fairy (female) Bed bug (it grows as it hits you) Poop monster Mummy Alien Blob Clown Lizard man FLOWER monster (evil rose bush) Stinging needle plant monster (looks like he is inebriated) Frog monster Skeleton Tooth fairy Santa Claus Easter bunny Uncle Sam Witch Wizard Cupid Turkey monster Pig monster Pizza monster Rat monster Lava monster Mud monster Sand monster Rock monster (GRANITE OR SANDSTONE) GOLD monster (solid gold man) DIAMOND monster (solid diamond twinkling female) Burning man monster Black widow sexy lady (female) Eyeball monster (eyeballs everywhere) Big foot Yeti Hydra Faun (horned man with deer legs) Snake women (medusa)

### Ingredient Combinations to Create Monsters: (the Monster's Name Will Come Later)(Combinations Must be Entered in Order Like a Code)

VAMPIRE: graveyard dirt+bat wings ZOMBIE: graveyard dirt+flesh WEREWOLF: graveyard dirt+wolves ear SKELETON: graveyard dirt+bone dust TREE MONSTER: oak leaves+dirt JUNGLE MONSTER: vines+mud TRASH MONSTER: bag of garbage+sewage GRANDMA: dentures+graveyard dirt+tea bag COBRA HEAD MONSTER: cobra+old shoe+jacket BANSHI: PURCHASE ONLY GHOUL: MISSION UNLOCK OCTOPUS MAN: tentacles+eyeball+old shoe CONJOINED TWINBABY: MISSION UNLOCK BLACK CAT MONSTER: graveyard dirt+cat paw ROACH MONSTER: bag of trash+dirt+pizza MINATOR: flesh+bullhorns+graveyard dirt DEMON: graveyard dirt+flesh+lava ELECTRIC EAL: light bulb+fish scales+jacket SHARK MAN: shark tooth+jacket+fish scales CRAB MONSTER: crab legs, old shoes, jacket PHOENIX: raven feather+lava+graveyard dirt EAGLE MAN: fried chicken+lava+old shoes DRAGON: lava+shark tooth+raven feather SUCCUBUS: PURCHASE ONLY GRASSHOPPER: grass+jacket+tea bag FISH MAN: dentures+fish scales+shark tooth MERMAID: PURCHASE ONLY TROLL: grass+sewage+crab legs FROG MAN: fish scales+lizard+sewage LIZARD MAN: lizard+shark tooth+vines STINGING NEDDLE PLANT: dentures+oak leaves+vines CLOWN: MISSION REWARD SPRIG: raven feather+vines+teabag FAIRY: raven feather+wolves ear+oak leaves BED BUG: dirt+jacket+flesh POOP MONSTER: poop+old shoe+cobra MUMMY: flesh+sand+cobra ALIEN: MISSION REWARD BLOB: poop+sewage+tea bag BIG FOOT: flesh+dentures+oak leaves YETI: ice cubes+flesh+dentures EYEBALL MONSTER: old shoe+eyeball+shark tooth BLACK WIDOW MISTRESS: eyeball+spider+snake skin HYDRA: cobra+snake skin+eyeball SNAKE LADY: PURCHASE ONLY FAUN: wolves ears+deer antler+old shoes PIZZA SLICE MONSTER: old cheese+eye ball+flesh BURNING MAN: lava+stick+flesh PIG MAN: holiday ham+gun powder+sprinkled donut
HOLIDAY SEASON MONSTERS: (PURCHASE ONLY): TOOTH FAIRY: SANTA CLAUS: EASTER BUNNY: WITCH: WIZARD: CUPID: TURKEY MONSTER: GOLD AND DIAMOND MONSTER: UNCLE SAM: Leprechaun MONSTER CUSTOMISATION: (Once you unlock the “bio lab” option screen, you can change your monsters appearance): HAIR COLOR: SKIN COLOR: FUR COLOR: GENDER: EYE COLOR: ADD EYE WEAR: HATS: JEWELRY: CIGAR: CIGARETTE: LIP STICK: CLOTHING: ADD ROBOTICS: SPLICE 2 MONSTER ALTOGETHER: BREED: FAT OR SKINNY

### Monster Descriptions:

TREE MONSTER: two legs consisting of roots and bark, patches of grass and dirt. a face whittled in the trunk of the tree with missing bark. Arms made of branches that shed leaves when it attacks. JUNGLE TREE MONSTER: a blue rubber tree. with both legs and arms made of vines with thorns and multi colored poison flowers. Its face looks like an evil old man in rotting wood.

TRASH MONSTER: walking pile of trash, with plastic cups, banana peels, random food intertwined (fish bones, pizza, celery, fried chicken, spaghetti coke bottles, milk container, juice box, cup cake) in its body. its face is made up of rotten produce. GRANDMA: hunch back, English grandma, pink sweater with a fluffy cat stitched on it. Light Blue pants. orthopedic shoes, a cane. Wrinkled face with random white facial hair, yellow teeth (horribly jagged and cracked, Green Stains and out of place. thick glasses. COBRA HEAD MONSTER: spread open king cobra head. Dressed in ancient Egyptian gold armor. Decorated with hieroglyphs, fine jewels that sparkle. Decorative arm braces again with hieroglyphs and jewels. Hands and feet covered on elaborate snake skin. Teeth that leek venom. Eyes (with a electric illuminating plasma ball glowing as the pupils. BANSHI: sexy female, dressed in flowing black laced night gown. Red lipstick. Whore like makeup. Big breasts that almost stick out. Pale faced complexion with long purple and blue hair.

GHOUL: gangly skinny man, skin melting away. Ear missing and the inside of its head is exposed. A few strands of curly hair are left on its forehead. He is missing fingers on both hands and also is missing a foot (leg is cut off at the ankle with flesh and bone hanging out. His clothing is torn apart (ripped up suit).

OCTOPUS MAN: purple and green stripes on black tentacle. yellow suction cups. Its head also stripped purple and green, piercing yellow and red eyes that glow and sparkle. CONJOINED TWIN BABY: attached at the head neck and torso. One baby is fat the other skinny. Both in a soiled diaper, with pee and poop dripping out. Spaghetti stuck to their belly. A tiny pony tail off center on top their connected head.

BLACK CAT MONSTER: huge evil black cat. Missing fur from mange (scratched bald spots). Scabs and scratches on the face. White eyes with a scratch wound in the left eye (puss and slim leaking out of the wound). its tail torn and bloody. Its paws look as if they had been burnt many times. ROACH MONSTER: huge cockroach. His face as a sinister grin. His exoskeleton is a swirls of shinny black and brown. Muscular thorax. Muscular arms and legs (right arm has a nuclear waste ooze container tattoo). The monster is smoking a cigarette (before the fight he flicks it at opponent). MINATOR: muscular bull walking on two legs. He is wearing a Greek robe. Bloody olive leave necklace. Gold arm braces (with ancient Greek text on them). his hooves are layered in gold. Finger nails are gold as well. A gold ring is in his nose (with a very small inscription of the symbol for the lost city of Atlantis).

DEMON: a small very skinny. Bones and ribcage are exposed. Melted flesh and bubbling open soars riddle its body. A burning glow from inside vanes turns into flowing lava as the soars pulsate. Long burnt to a crisp fingers. Melting facial features (elongated eye sockets, jaw line, nose holes. Melting ear lobes. No genitals. 6 Tiny off white stained horns running parallel from front to mid way back on the head. The tips of the horns looks like burning wood ambers.

ELECTRIC ELE: multicolor tie dye arrangement of blue, yellow, amethyst, over green skin. The tie dye color arrangement pulsates with electric current running through it. SHARK MAN: tiger shark head (gold and shinny onyx skin). pinstriped white suit. 2 tone doc martin shoes. On his hands are a diamond pinky ring, Rolex watch, and a radioactive ooze tattoo. His teeth are bloody. When he takes damage he vomits fish bones, pirates treasure.

CRAB MONSTER: multicolor combination of swirling reds decorates his shell. Dressed in gladiator's armor (Light bronze colored metal slightly dented)(leather strips and bronze buckles). His claws are bronze layered shinny and sharp. The eyes are protected with bronze eye lid shields. PHOENIX: a muscular bird that changes color rapidly (a mixture of neon, metallic, and chrome. Multi color bright fire radiates around it. Its feathers glisten like burning wood (the tips sizzling and glowing like embers).

EAGLE MAN: giant bald eagle. Pearl white feathers. Piercing blue eyes. Gold talons with chrome nails. Muscular body with a chrome muscle chest plate (chrome has a reflective mirror finish). chrome ankle braces (reflective mirror finish). Gold beak (angry expression with blood splatters). DRAGON: forest green and black scales (jewel like appearance). the inside wing skin (cream colored leather texture). eyes (pupils fire like the center of the sun, surround by a star filled black outer space like scene). claws are bone like (liquid acid burning and sizzling at the tips), sharp and damage the ground as the dragon moves. Two horns stick out of its head (dripping acid on the face sizzles and absorbs back into the Dragon, and squirts out of its nose). SUCCUBUS: sexy slender woman, Regal looking red dress, diamond jewels drape her neck. Ruby red stilettos (jewel like shine high heal). Diamond bracelets and Royal looking rings. She has cat like eyes with faint hints of yellow green and blue. Her lips are full and voluptuous. She has long flowing blonde, red, and light brown.

GRASSHOPPER: neon green glowing huge grasshopper. He is wearing a karate outfit (with a push lawnmower on the chest) with Nunchaku (wooden with shinny chrome chain's and the same glowing writings as the bandana) on his side tied with his black belt with 5 red stripes (5th degree black belt). Tied around his head is a white colored bandana (Bruce lee written in Asian) with red metallic fire glowing writing. FISH MAN: sheep head fish (with 2 rows of yellow and green buck teeth) in a dirty orange prison outfit (inmate number #85). Chrome chains and broken shackles. Fingers are riddled with fish hooks (a few still have shrimp on them)(pinky ring with a red gargoyle gemstone). shinny silver eyes (with storm cloud patters running through them). he is bare foot (ugly ingrown toe nails with toe jam and dirt in them). cracked and broken toe nails (a few hairs on some toes).

MERMAID: beautiful looking blonde (platinum, gold, silver sparkling hair). her body is covered in shinny peacock like scales. Her breast are covered by shinny sand dust. Her human skin is slightly tan. Her eyes are a vibrant blue (with crashing waves in them) her mouth is full of jagged pearl teeth. TROLL: large and oafish dirty green skin with warts and blemishes. long lanky arms. A fat beer belly (with belly lint) that pokes out of his clothes (torn potato sacks tied together with vines). yellow stained teeth with bloody gums. Cracked and broken teeth. snot and boogers pour from its nose (he licks it and giggles). When he moves he farts a cloud of smoke (green army camouflage color). his feet are callused and dirty (crust like concrete), long spiraling toe nails that point in different directions. SPRIG: tiny but powerful fairy (muscular tree bark skin a combination of grey and brown) twig like fingers and limbs (a flowing green liquid in the vanes) the wings are shinny transparent (gothic decorations woven through out the wing pattern). FAIRY: tiny but strong. She has red hair (blood red) fair skin and red eyebrows (designed in a sexy way). she is wearing a purple tank top and mini skirt (with black leather trim). Her eyes are a mixture of colors (kaleidoscope effect). Her wings are transparent but have a purple mosaic designs (almost invisible). POOP MONSTER: a pile of changing poop (his skin changes between different poop colors. There are bits of corn, bubble gum, lucky charms, carrots and peas.) No eyes just eye sockets (dripping poop off of eyebrow locations). His mouth has no teeth (dripping poop when the mouth moves). The ground gets muddy when he moves (flies circle the stinking mass) and (a fog of poopie air develops). MUMMY: skinny dusty man rapped in stained dressings (dusty, dirty, brown, yellow, and dried blood). His mouth is covered with same dressing and scarabs (Egyptian beetle) crawls in and out of its face. His eyes are deep dark sockets with tiny red glowing pupils (flowing back and forth like red wine in a glass). his right leg is turned inward and the knee is broken and protruding out (Egyptian beetle crawling in and out). The Egyptian Beatle had glowing hieroglyphs on its back. Alien: grey smooth skin. Large black onyx eyes (shinny). long arms that tough the feet with 2 fingers and a thumb. Small mouth with no teeth thin lips. A long black tongue (the tip of the tongue has a mouth with 3 rows of teeth spiraling around the inside and black slim drips out of the mouth). his feet are long with 4 toes that look like fingers. Neon blue vanes surge through out its body like electricity. He has cauliflower ear and leaking black ooze. BIG FOOT: long brown fur (with oak leaves and sticks tangled in it). Human like facial features (wrinkles in the forehead, scars on the left cheek). Similar fur looking facial hair. Bear feet missing fur and big toe on the right foot is missing the nail. Very muscular body features (8 pack abs, big chest, big biceps, big calves and thighs. His hands are human like and crusted with dirt. YETTI: silver and light blue fur (twinkling like a diamond). Cold blue eyes (glow). Frozen fur surround the hands (fingernails twinkle). The fur on his legs and body have random spots of frozen ice sickles. His feet are furry with icy toes (twinkling). HYDRA: 3 headed serpent #1 (crimson and gold scales), #2 (black and neon green), #3 (teal and chrome). The body is a fusion of all the colors (spiraling rainbow like water down a drain). Sharp blood dripping claws. Teeth sharp but decaying and stained. PIZZA MONSTER; A slice of pizza with arms and legs. Pepperoni, sausage, onions, peppers, and extra cheese bubble and drip all over this pizza. His hands are crust with melted cheese dripping. His feet are covered in pizza toppings (pepperoni, sausages, peppers, onions, olives and melting cheese) to hold him to the ground. His face is made of (a burnt bubble of cheese on the pizza). When he talks pizza drips out of his mouth. FAUN: white tail deer legs with shinny black hooves. A chubby mans body with stomach and chest hair. A devilish beard and mustache. Pointed ears with tiny gold earrings in the top of them. A pan flute made of ancient wood is hung around his neck. Thick curly eyebrows (devilishly twisted). Hazel eyes that glow and glisten.

CLOWN: over weight beer belly clown. Wearing a polka dots belly shirt. Polka dots white pants (dots only on left leg) and white jacket (polka dots on right arm only). Rainbow colored Afro (changing color slowly). Slowly changing happy and sad faced, face paint. STINGING NEEDLE PLANT: Green tropical looking fern with sharp needles sticking out of it. Arms and legs are vine like (braded with red and orange stripped leaves). his face (looks angry drunk) yellow and red eyes. Bloody needle teeth and a red snakes tongue.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A system to create interactive monster images comprising of:
an interactive science lab, wherein a user enters the interactive science lab through a software application;
an assortment of equipment within the interactive science lab such as flasks, beakers, test tubes and DNA research;
interactive monster images created by the user using the assortment of equipment by cloning, breeding or genetically altering characteristics;
various levels of participation based on player activity;
a variety of ingredients for monster image creation such as swamp water, flesh, teeth, tears, human heart, tentacles, eyeballs, scales of the hand, skin, snakeskin, worms, roaches, lizards;
a purchasing option available to purchase a selection of the variety of ingredients for creation of the monster images.

2. The system to create interactive monster images according to claim 1 wherein a series of missions are engaged through the monster creation process and the user engages in various monster activities to improve monster characteristics such as biting, attacking, feeding and engaging in tournaments.

3. The system to create interactive monster images according to claim 1 further including setting parameters associated with each monster image and associated healing capabilities, fighting capabilities and hunting capabilities.

4. The system to create interactive monster images according to claim 1 further including point system associated with monster engagement such as point system for fighting techniques and fighting capabilities.

5. The system for monster image control creation according to claim 1 including a plurality of monster images such as zombies, lizards, vampires, werewolves, tree monsters, cobra head monster, roach monster, frog man, lizard man, pizza slice monster and turkey monster.
